(19) United States
(12) Patent Application Publication
(10) Pub. No.: US 2013/0129327 A1
(43) Pub. Date: May 23, 2013

(54) SYTEM AND METHOD FOR RAPID HEATING OF FLUID

(71) Applicants: Cedric Israelsohn, Doncaster (AU); Robert C. Van Aken, Prahran (AU)

(72) Inventors: Cedric Israelsohn, Doncaster (AU); Robert C. Van Aken, Prahran (AU)

(21) Appl. No.: 13/520,667

(22) PCT Filed: Jan. 7, 2011
(86) PCT No.: PCT/AU11/00016

§ 371 Date: Dec. 26, 2012

(30) Foreign Application Priority Data
Jan. 7, 2010 (AU) 2010900056

(51) Int. Cl. H05B 3/60; F24H 1/10

(52) U.S. Cl. CPC H05B 3/60; F24H 1/102
USPC 392/312; 392/314; 392/316; 392/338

(57) ABSTRACT

A heat generator and method for generating heat is described and includes an electric fluid heater for receiving fluid and for heating the fluid by passing electric current through the fluid, which heats the fluid by virtue of the fluids resistive properties. A fluid receptacle within a heat exchanger receives heated fluid from the electric fluid heater and transfers the heated fluid to a substance via the heat exchanger, wherein the substance is in proximity to the heat exchanger. The method includes pumping fluid to an electric heater which heats the fluid by passing electric current through the fluid for heating the fluid through resistive properties. The method further includes pumping heated fluid from the electric fluid heater into a fluid receptacle within a heat exchanger, wherein the fluid receptacle transfers heat from the heated fluid via a heat exchanger to a substance in proximity to the heat exchanger.

### CROSS-REFERENCE TO RELATED APPLICATIONS

The present application claims priority from AU2010900056 the content of which is incorporated herein by reference.

### TECHNICAL FIELD

The present invention relates to a method for generating heat to heat a substance and a heat generator for heating a substance. More particularly, the present invention relates to rapidly heating a substance using an electrically energised heating system that uses fluid as the medium for heating.

### BACKGROUND OF THE INVENTION

Rapid heating of substances is desirable in a range of fields, including automotive, marine, aeronautical and aerospace. For instance battery performance in cold climates is an ongoing concern for hybrid electric vehicles. It is therefore necessary to warm up the batteries in, hybrid electric vehicles in order to achieve acceptable power and energy performance from the batteries. In an especially cold environment both the battery and the hybrid electric vehicle's engine are cold. To avoid sluggish engine performance, it is desirable to preheat the engine block. In other situations it is the air in a compartment of the vehicle which requires heating for the comfort of passengers.

A heater core or heat exchange system is typically used in heating fluids or gasses. As an example, heated engine coolant, heated by a vehicle's engine, is passed through a heat exchanger of a heater core installed in the vehicle. Air is forced past the heat exchanger by a fan and receives heat from the heat exchanger that is heated engine coolant. The heated air is then directed into the passenger compartment for the comfort of occupants, or may be directed to the windscreen for demisting or de-icing.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY OF THE INVENTION

A method to generate heat to heat a substance is provided, the method comprising:
pumping fluid to an electric fluid heater;
the electric fluid heater heating the fluid by passing electric current through the fluid, which by virtue of the fluid's electrical resistive properties the fluid will heat up; and
pumping heated fluid from the electric fluid heater into a fluid receptacle within a heat exchanger; wherein the fluid receptacle transfers heat from the heated fluid via the heat exchanger to a substance, the substance being in proximity to the heat exchanger.

A heat generator to heat a substance is provided, the heat generator comprising:
an electric fluid heater operable to receive fluid and to heat the fluid by passing electric current through the fluid, which by virtue of the fluid's electrical resistive properties the fluid will heat up; and
a fluid receptacle within a heat exchanger to receive heated fluid from the electric fluid heater and to transfer heat from the heated fluid to a substance via the heat exchanger, wherein the substance to be heated is in proximity to the heat exchanger.

This method of heating a substance uses the heat generated by a fluid that is being electrically energised in a controlled fashion. The heat from the fluid can be passed to the substance requiring heating by any means available. Typically the substance to be heated will be positioned or passed in very close proximity to or in direct contact with the fluid receptacle containing the heated fluid. In this way heat exchange will occur and the substance to be heated will heat up. The temperature of the heated substance is controlled by maintaining accurate control of the temperature of the heated fluid.

Preferably the fluid receptacle forms a closed loop with the electric fluid heater. In such an embodiment the method comprises circulating the fluid throughout the closed loop.

Preferably the fluid will typically be circulated in the fluid receptacle which is either in very close proximity to, or in direct contact with the substance to be heated.

The electric fluid heater preferably operates on electrical power, which may be AC or DC power from an electrical source.

The heat generator is not limited to the specific type of fluid heated by the electric fluid heater though it should be appreciated that it will be one that is electrically and thermally conductive. The selection of the fluid used in any system will in part depend on the desired temperature to be obtained and the application in which the heated substance is to be used. The thermally conductive fluid may be selected from, but not limited to water, ethylene glycol, propylene glycol, a mineral or synthetic oils and nanofluids.

Nor is the heat generator limited to the form of the fluid receptacle, the configuration of which will depend on the type of substance to be heated.

The fluid receptacle may form a component of a heat exchanger. In one embodiment the substance to be heated may be air and a heat exchanger in the form of a radiator may be provided. In such an embodiment the radiator may transfer heat from the heated fluid to the air (substance) as it flows through the radiator. In other embodiments the fluid receptacle may form a component of a heat exchanger or the like for deployment of a diverse range of applications including polymer curing, autoclave operation, de-icing of windscreens, heating of batteries, and engine preheating.

The electric fluid heater may heat the electrically resistive fluid by passing the fluid along a flow path from an inlet to an outlet.

The flow path may comprise at least first and second heating assemblies positioned in parallel along the flow path such that fluid passing the first heating assembly passes the second heating assembly in parallel, each heating assembly comprising at least one pair of electrodes between which the electrically resistive fluid is passed, which, by virtue of its electrical resistance will draw electric current as it passes through the fluid passage along the flow path.

The flow path may comprise at least first, second and third parallel heating assemblies positioned along the flow path such that fluid passes through all three or more heating assemblies in parallel.

The electric fluid heater may be further operable to measure fluid conductivity, flow rate and fluid temperature at the inlet and outlet. From the measured fluid conductivity, flow rate and temperature the electric fluid heater may determine the required power to be delivered to the fluid by the first and second or n^{th} parallel heating assemblies to raise the fluid temperature the desired amount.

In certain embodiments, at least one of the heating assemblies of the electric fluid heater may comprise at least one segmented electrode, the segmented electrode comprising a plurality of electrically separable electrode segments allowing an effective active area of the segmented electrode to be controlled by selectively activating the segments such that upon application of a voltage to the segmented electrode current drawn will depend upon the effective active area. Further, electrode segment selection may be carried out in a manner to ensure peak current limits are not exceeded. In such embodiments, the measurement of inlet conductivity permits operation of the device to be prevented if such current limits will not safely be met.

In certain embodiments, variations in fluid conductivity are substantially continually accommodated in response to measurements of incoming fluid conductivity. Fluid conductivity may be determined by reference to the current drawn upon application of a voltage across one or more electrodes of one or more heating assemblies.

Further embodiments utilise the measured fluid conductivity to ensure that no violation occurs of a predetermined range of acceptable fluid conductivity within which the heat generator is designed to operate.

Moreover, by providing a plurality of parallel heating assemblies, each heating assembly is able to be operated in a manner that allows for changes in electrical conductivity of the fluid with increasing fluid temperature. For example, water conductivity increases with temperature, on average by around 2% per degree Celsius. Where fluid is to be heated by scores of degrees Celsius, for example from room temperature to 60 degrees Celsius or 90 degrees Celsius, inlet fluid conductivity can be substantially different to outlet fluid conductivity. Electrically energizing the fluid while passing through the parallel heating assemblies along the flow path, allows each heating assembly to operate within a defined temperature range. Thus each heating assembly may apply the appropriate power that is applicable to the fluid conductivity within that defined temperature range rather than attempting to apply power in respect of a single or averaged conductivity value across the entire temperature range.

One or more of the embodiments may further comprise a downstream fluid temperature sensor to measure fluid temperature at the outlet, to permit feedback control of the fluid heating.

In an embodiment, each heating assembly may comprise substantially planar electrodes between which the fluid flow path passes. Alternatively, each heating assembly may comprise substantially coaxial cylindrical or flat members with the fluid flow path comprising an annular space. The fluid flow path may define a plurality of parallel flow paths for the fluid.

In an embodiment, the heat generator may comprise three or more heating assemblies, each assembly having an inlet and an outlet, the assemblies being connected in parallel and the control means initially selecting electrode segments in accordance with the measured incoming fluid conductivity, the control means controlling power to an electrode pair of each assembly in accordance with the required fluid temperature which is determined by measuring the system inlet and outlet temperatures.

The volume of fluid passing between any set of electrodes is preferably determined by measuring the dimensions of the passage within which the fluid is exposed to the electrodes taken in conjunction with fluid flow.

Similarly, the time for which a given volume of fluid will receive electrical power from the electrodes may be determined by reference to the flow rate of fluid through the system. The temperature increase of the fluid is proportional to the amount of electrical power applied to the fluid. The amount of electrical power required to raise the temperature of the fluid a known amount, is proportional to the mass (volume) of the fluid being heated and the fluid flow rate through the flow path. The measurement of electrical current flowing through the fluid can be used as a measure of the electrical conductivity, or the specific conductance of that fluid, and hence allows selection of electrode segments to be activated together with system control and management required to keep the applied electrical power constant or at a desired level. The electrical conductivity, and hence the specific conductance of the fluid being heated will change with rising temperature, thus causing a specific conductance gradient along the path of fluid flow.

The energy required to increase the temperature of a body of fluid may be determined by combining two relationships:

Energy=Specific Heat Capacity×Density×Volume×Temp-Change Relationship (1)

or

The energy per unit of time required to increase the temperature of a body of fluid may be determined by the relationship:

$$Power ( P ) = \frac{\begin{matrix}Specific Heat Capacity ( SHC ) \times \\ Density \times Vol ( V ) \times Temp \text{-} Change ( Dt )\end{matrix}}{Time ( T )}$$

For analysis purposes where water is concerned, the specific heat capacity of water, for example, may be considered as a constant between the temperatures of 0 deg Celsius and 100 deg Celsius. The density of water being equal to 1, may also be considered constant. Therefore, the specific heat or amount of energy required to change the temperature of a unit mass of water, 1 deg Celsius in 1 second is considered as a constant and can be labelled “k”. Volume/Time is the equivalent of flow rate (Fr). Thus the energy per unit of time required to increase the temperature of a body of fluid may be determined by the relationship:

$$Power ( P ) = \frac{k \times Flow rate ( Fr ) \times Temp \text{-} Change ( Dt )}{Time ( T )}$$

Thus if the required temperature change is known, the flow rate can be determined and the power required can be calculated.

In a non-limiting example where the substance to be heated is the air in a vehicle's cabin, a controller on the vehicle instrument panel or a remote control device is operated when a user requires heated air. This input may be detected by or passed to the electric fluid heater and cause the initiation of a heating sequence. The temperature of the inlet fluid may be measured and compared with a preset desired temperature for fluid output from the system. From these two values, the required change in fluid temperature from inlet to outlet may be determined.

Of course, the temperature of the inlet fluid to the electrode assemblies may be repeatedly measured over time and as the value for the measured inlet fluid temperature changes, the calculated value for the required temperature change from inlet to outlet of the electrode assemblies can be adjusted accordingly. Similarly, with changing temperature, mineral content and the like, changes in electrical conductivity and therefore specific conductance of the fluid may occur over time. Accordingly, the current passing through the fluid will change causing the resulting power applied to the fluid to change, and this may be managed by selectively activating or deactivating elements of the segmented electrode(s). Repeatedly measuring the temperature outputs of the heating sections over time and comparing these with the calculated output temperature values will enable repeated calculations to continually optimise the power applied to the fluid.

In one preferred embodiment, a computing means provided by the microcomputer controlled management system is used to determine the electrical power that should be applied to the fluid passing between the electrodes, by determining the value of electrical power that will effect the desired temperature change between the heating assembly inlet and outlet, measuring the effect of changes to the specific conductance of the water and thereby selecting appropriate activation of electrode segments and calculating the power that needs to be applied for a given flow rate.

### Relationship (2) Control of Electrical Power

In preferred embodiments of the present invention, the electrical current flowing between the electrodes within each heating assembly, and hence through the fluid, is measured. The heating embodiment input and output temperatures are also measured. Measurement of the electrical current and temperature allows the computing means of the microcomputer controlled management system to determine the power required to be applied to the fluid in each heating assembly to increase the temperature of the fluid by a desired amount.

In one embodiment, the computing means provided by the microcomputer controlled management system determines the electrical power that should be applied to the fluid passing between the electrodes of each heating assembly, selects which electrode segments should be activated in each segmented electrode, and calculates the power that needs to be applied to effect the desired temperature change.

As part of the initial heating sequence, the applied voltage may be controlled in such a way so as to determine the initial specific conductance of the fluid passing between the electrodes. The application of voltage to the electrodes will cause current to be drawn through the fluid passing there-between thus enabling determination of the specific conductance of the fluid, being directly proportional to the current drawn there-through. Accordingly, management of the electrical power that should be supplied to the fluid flowing between the electrodes in each heating assembly can be correctly applied, in order to increase the temperature of the fluid flowing between the electrodes in each heating assembly by the required amount. The instantaneous current being drawn by the fluid is preferably continually monitored for change along the length of the fluid flow path. Any change in instantaneous current drawn at any position along the passage is indicative of a change in electrical conductivity or specific conductance of the fluid. The varying values of specific conductance apparent in the fluid passing between the electrodes in the heating assemblies, effectively defines the specific conductivity gradient along the heating path.

Preferably, various parameters are continuously monitored and calculations continuously performed to determine the electrical power that should be supplied to the fluid in order to raise the temperature of the fluid to a preset desired temperature in a given period.

### BRIEF DESCRIPTION OF THE DRAWINGS

An example of the invention will now be described with reference to the accompanying drawings, in which:

FIG. 1 illustrates a first embodiment of a heat generator to heat a substance;

FIG. 2 illustrates a second embodiment of a heat generator to heat a substance; and

FIG. 3 illustrates the electric fluid heater shown in FIG. 1 or FIG. 2 which has a parallel arrangement of three heating assemblies, each assembly having a pair of electrodes, one of each of which are segmented into two electrode segments.

### DESCRIPTION OF THE PREFERRED EMBODIMENTS

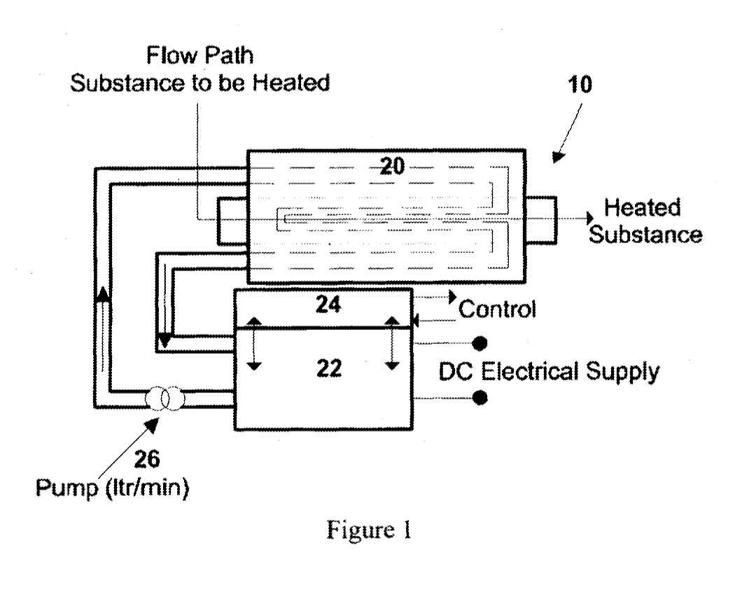

FIG. 1 illustrates an embodiment of a heat generator 10 to heat a substance, in this case. The heat generator 10 shows an electric fluid heater 22 controlled by an electronic controller 24 and coupled to a fluid receptacle which forms a component of a conditioning/heat exchanger 20. The various possible configurations of the heat exchanger 20 are known in the art. The embodiment of FIG. 1 provides for the electric fluid heater 22 to effectively be coupled to the substance being heated via the heat exchanger 20. The electric fluid heater 22 is used to heat fluid that is circulated between the electric fluid heater 22 and the heat exchanger 20 using a small pump 26. The heat exchanger 20 is used to transfer heat to the substance being heated. The level of heat transferred is controlled by the electric fluid heater and electronic controller 24.

In this, or similar embodiments, the electric fluid heater 22, uses multiple electrode sections, and heats fluid through the direct application of electrical energy into the fluid to cause heating within the fluid itself under electronic control.

The electric fluid heater voltage is provided by an electrical source or a battery, and manages a set fluid flow rate and changes in fluid conductivity. Being a closed loop continuous flow fluid heater, with fluid flow facilitated via a pump, the electric fluid heater 22 operates within constrained ranges of variation of temperature and conductivity.

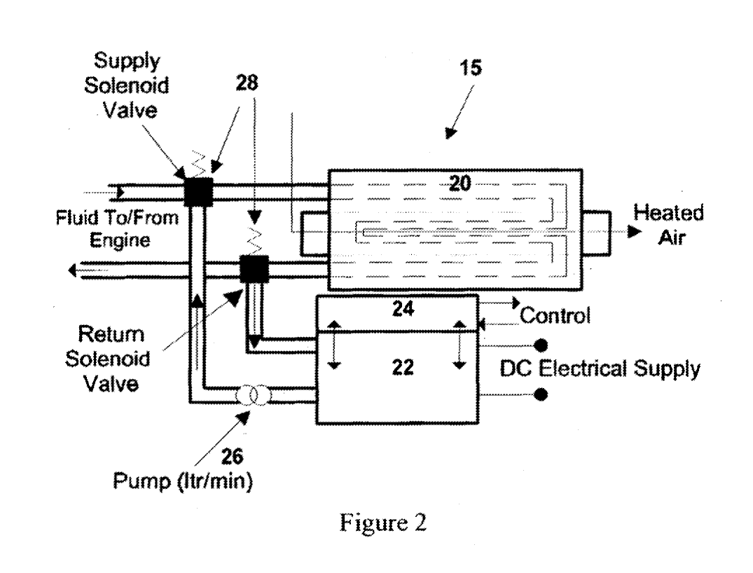

FIG. 2 illustrates a further embodiment of a heat generator 15 to heat a substance, with like numbers illustrating like components. In this example, the electric fluid heater 22 is used to heat motor vehicle engine coolant. The heated engine coolant is pumped through an existing fluid receptacle within a heat exchanger 20 that is used to heat the air being transferred into the motor vehicle interior. In effect, the heated fluid is circulated in a closed loop between the electric fluid heater 22 and the heat exchanger 20 using a small pump 26. The solenoids 28 in line with the heat exchanger 20 supply/return engine coolant being heated. The heat exchanger 20 is used to heat air to be transferred into the vehicle cabin. When the running engine coolant is sufficiently hot enough to allow air to be effectively heated by the heat exchanger 20, the electric fluid heater 22 is isolated using the solenoids 28.

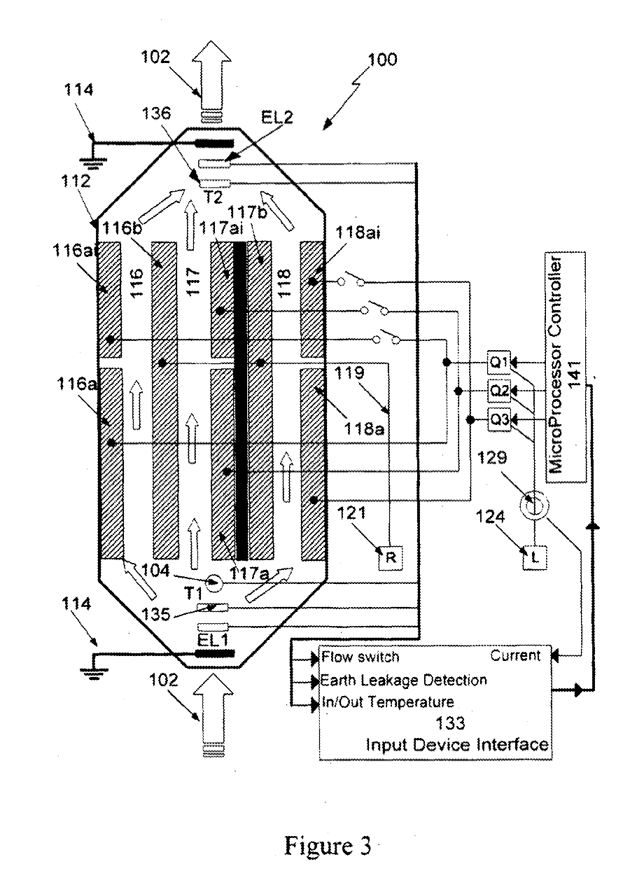

FIG. 3 is a schematic block diagram of a further embodiment of a heat generator 100 to heat a substance, in which the substance to be heated is caused to flow through the body 112 of an electric heater. The body 112 is preferably made from a material that is electrically non-conductive, such as synthetic plastic material. However, depending on the application, the body 112 may be connected to metallic fluid pipe, such as aluminium pipe, that is electrically conductive. Accordingly, earth mesh grids 114 shown in FIG. 3 are included at the inlet and outlet of the body 112 so as to electrically earth any metal tubing connected to the apparatus 100. The earth grids 114 would ideally be connected to an electrical earth of the electrical installation in which the heating system of the embodiment was installed. As the earth mesh grids 114 may draw current from an electrode through water passing through the apparatus 100, activation of an earth leakage protection within the control system may be effected. In a particularly preferred form of this embodiment, the system includes earth leakage circuit protective devices.

In operation, fluid flows through the body 112 as indicated by flow path arrows 102.

The body 112, which defines the fluid flow path, is provided with three heating sections comprising respective parallel heating assemblies 116, 117 and 118. The electrode material may be any suitable inert electrically conductive material or a non-metallic conductive material such as a conductive plastics material, carbon impregnated, coated material or the like. It is important that the electrodes are selected of a material to minimise chemical-reaction and/or electrolysis.

The segmented electrode of each electrode pair, being segmented electrodes 116a, 117a and 118a, is connected to a common switched path via separate voltage supply power control devices Q1, Q2, . . . , Q9 to the live side 124 of the electrical supply, while the other of each electrode pair 116b and 117b is connected to the return side voltage supply 121. The separate voltage supply power control devices Q1, Q2, . . . , Q9 switch the live electrical supply 124 in accordance with the power management control provided by microprocessor control system 141. The total electrical current supplied to each individual heating assembly 116, 117 and 118 is measured by current measuring device 129. The current measurements are supplied as an input signal via input interface 133 to microprocessor control system 141 which acts as a power supply controller for the heating assemblies.

The microprocessor control system 141 also receives signals via input interface 133 from a flow switch device 104 located in the body 112. The volume of fluid passing between any set of electrode segments may be accurately determined by measuring ahead of time the dimensions of the passage within which the fluid is exposed to the electrode segments taken in conjunction with fluid flow. Similarly, the time for which a given volume of fluid will receive electrical power from the electrode segments may be determined by measuring the flow rate of fluid through the passage. The temperature increase of the fluid is proportional to the amount of electrical power applied to the fluid. The amount of electrical power required to raise the temperature of the fluid a known amount, is proportional to the mass (volume) of the fluid being heated and the fluid flow rate through the passage. The measurement of electrical current flowing through the fluid can be used as a measure of the electrical conductivity, or the specific conductance of that fluid and hence allows determination of the required change in applied power management required to keep the applied electrical power constant. The electrical conductivity, and hence the specific conductance of the fluid being heated, will change with rising temperature, thus causing a specific conductance gradient along the path of fluid flow.

The microprocessor control system 141 also receives signals via signal input interface 133 from an input temperature measurement device 135 to measure the temperature of input fluid to the body 112, an output temperature measurement device 136 measuring the temperature of fluid exiting the body 112.

The device 100 of the present embodiment is further capable of adapting to variations in fluid conductivity, whether arising from the particular location at which the device is installed or occurring from time to time at a single location. Variations in fluid conductivity will cause changes in the amount of electrical current drawn by each electrode for a given applied voltage. This embodiment monitors such variations and ensures that the device draws a desired level of current by using the measured conductivity value to initially select a commensurate combination of electrode segments before allowing the system to operate. Typically, each electrode 116a, 117a, 118a is segmented into two electrode segments, 116ai, 117ai, and 118ai. For each respective electrode, the ai segment is fabricated to form about 40% of the active area of the electrode, the a segment is fabricated to form about 60% of the active area of the electrode. Selection of appropriate electrode segments or appropriate combinations of electrode segments thus allows the appropriate electrode surface area to be selected. Consequently for highly conductive fluid a smaller electrode area may be selected so that for a given voltage the current drawn by the electrode is prevented from rising above desired or safe levels. Conversely, for poorly conductive fluid a larger electrode area may be selected so that for the same given voltage adequate current will be drawn to effect the desired power transfer to the fluid. Selection of segments can be simply effected by switching the power switching devices Q1, . . . Q9 in or out as appropriate.

In particular the combined surface area of the selected electrode segments is specifically calculated to ensure that the rated maximum electrical current values of the system are not exceeded.

The microprocessor control system 141 receives the various monitored inputs and performs necessary calculations with regard to electrode active area selection, desired electrode pair power to provide a calculated power amount to be supplied to the fluid flowing through the body 112. The microprocessor control system 141 controls the pulsed supply of voltage from electric supply connected to each of the heating assemblies 116, 117, 118. Each pulsed voltage supply is separately controlled by the separate control signals from the microprocessor control system 141 to the power switching devices Q1, . . . , Q9.

It will therefore be seen that, based upon the various parameters for which the microprocessor control system 141 receives representative input signals, a computing means under the control of a software program within the microprocessor control system 141 calculates the control pulses required by the power switching devices in order to supply a required electrical power to impart the required temperature change in the fluid flowing through the body 112 so that heated fluid is emitted from the body 112 at the desired temperature.

The microprocessor control system 141 may have a defined maximum temperature which represents the maximum temperature value above which the fluid may not be heated. The system may be designed so that, if for any reason, the temperature sensed by the output temperature device 136 was greater than the defined maximum temperature, the system would be immediately shut down and deactivated.

The microprocessor control system 141 repeatedly performs a series of checks to ensure that:

(a) the fluid temperature at, the outlet does not exceed the maximum allowable temperature;
(b) leakage of current to earth has not exceeded a predetermined set value; and
(c) system current does not exceed a preset current limit of the system.

These checks are repeatedly performed while the unit is operational and if any of the checks reveals a breach of the controlling limits, the system is immediately deactivated. When the initial system check is satisfactorily completed, a calculation is performed to determine the required power that must be applied to the fluid flowing through the body 112 in order to change its temperature by the desired amount. The calculated power is then applied to heating assemblies 116, 117, 118 so as to quickly increase the fluid temperature as it flows through the body 112.

As the fluid flowing through the body 112 increases in temperature from the inlet end of the body, the conductivity changes in response to increased temperature. The input temperature measuring device 135 and output temperature measuring device 136 measures the temperature differential in the three heating assemblies in the body 112 containing the heating assemblies 116, 117, 118. The power applied to the respective heating assemblies 116, 117, 118 can then be managed to take account of the changes in water conductivity to ensure that an even temperature rise occurs along the length of the body 112, to maintain a substantially constant power input to each of the heating assemblies 116, 117, 118 to ensure greatest efficiency and stability in fluid heating between the input temperature measurement at 135 and the output temperature measurement at 136. The power supplied to the flowing fluid is changed by managing the control pulses supplied by the activated power switching devices Q1 . . . Q9 commensurate with the power required. This serves to increase or decrease the power supplied by individual heating assemblies 116, 117, 118 to the fluid.

The system 100 repeatedly monitors the fluid for changes in conductivity by referring to the current measuring device 129, and the temperature measurement devices 135, and 136. Any changes in the values for fluid conductivity within the system resulting from changes in fluid temperature increases, changes in fluid constituents as detected along the length of the body 112 or changes in the detected currents drawn by the fluid cause the computing means to calculate revised average power values to be applied to the heating assemblies. Changes in incoming fluid conductivity cause the microprocessor control system 141 to selectively activate changed combinations of electrode segments 116ai, 117ai, and 118ai. Constant closed loop monitoring of such changes to the system current, individual electrode currents, electrode segment fluid temperature causes recalculation of the power to be applied to the individual heating assemblies to enable the system to supply relatively constant and stable power to the fluid flowing through the heating system 100. The changes in specific conductance of the fluid passing through the separate segmented heating assemblies can be managed separately in this manner. Therefore the system is able to effectively control and manage the resulting specific conductance gradient across the whole system. This embodiment thus provides compensation for a change in the electrical conductivity of the fluid caused by varying temperatures and varying concentrations of dissolved chemical constituents, and through the heating of the fluid, by altering the power to accommodate for changes in specific conductance when increasing the fluid temperature by the desired amount.

It will be appreciated that any suitable number of electrode heating assemblies may lie used in the performance of the present invention. Thus, while the embodiments described show three heating sections for heating the fluid flowing through body 112, the number of heating assemblies in the passage may be altered in accordance with individual requirements or application specifics for fluid heating. If the number of heating assemblies is increased to, for example, six pairs, each individual heating assembly may be individually controlled with regards to power in the same way as is described in relation to the embodiments herein. Similarly, the number of electrode segments into which a single electrode is segmented may be different to two. For example, segmentation of an electrode into four segments having active areas in a ratio of 1:2:4:8 provides 15 values of effective area which may be selected by the microprocessor control system 141.

It is to be appreciated that by utilising heating assemblies which cause current to flow through the fluid itself such that heat is generated from the resistivity of the fluid itself, the present invention obviates the need for electrical resistance heating elements, thus ameliorating the problems associated with element scaling or failure.

Some portions of this detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is described in the foregoing context, it is not meant to be limiting as those of skill in the art will appreciate that various of the acts and operations described may also be implemented in hardware.

It should be borne in mind, however, that all of these and similar terms are to be associated with the appropriate physical quantities and are merely convenient labels applied to these quantities. Unless specifically stated otherwise as apparent from the description, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A method for generating heat to heat a substance, comprising:
pumping fluid to an electric fluid heater;
the electric fluid heater heating the fluid by passing electric current through the fluid, so that the electric current causes heating of the fluid by virtue of its resistive properties, wherein the heating of the fluid comprises passing the fluid along a flow path from an inlet to an outlet, and wherein the electric fluid heater comprises at least first and second heating assemblies positioned in parallel along the flow path such that fluid passing along the flow path passes the first and second heating assemblies in parallel; and
pumping heated fluid from the electric fluid heater into a fluid receptacle within a heat exchanger, wherein the fluid receptacle transfers heat from the heated fluid via a heat exchanger to a substance which is in proximity to the heat exchanger.

2. A method according to claim 1, wherein the fluid receptacle, heat exchanger and the electric fluid heater together form a closed loop and the method comprises circulating the fluid throughout the closed loop.

3. A method according to claim 1, wherein the fluid receptacle and heat exchanger are in direct contact with the substance to be heated.

4. A method according to claim 1, further comprising controlling the temperature of the heated fluid in order to control the temperature of the heated substance.

5. A method according to claim 1, wherein the electric fluid heater comprises at least first, second and third parallel heating assemblies positioned along the flow path such that fluid passing through the parallel heating assemblies heats up by virtue of the power applied.

6. A method according to claim 5, further comprising:
measuring fluid conductivity, set flow rate and fluid temperature at the inlet; and
from the measured fluid conductivity, flow rate and temperature determining a required power to be delivered to the fluid via electrode pairs of the parallel heating assemblies.

7. A method according to claim 5, where each heating assembly comprises a pair of electrodes, one electrode of each pair being segmented into two or more electrode segments.

8. A method according to claim 7, further comprising repeatedly measuring the temperature of the inlet fluid to each of the heating assemblies.

9. A method according to claim 7, further comprising optimising the power applied to the heated fluid by selectively activating or deactivating elements of one or more segmented electrodes.

10. A method according to claim 8, further comprising optimising the power applied to the heated fluid by repeatedly measuring the temperature outputs of each of the heating assemblies and comparing the measured temperature outputs with the calculated output temperature values.

11. A heat generator for heating a substance, the heat generator comprising:
an electric fluid heater operable for receiving fluid and for heating the fluid by passing electric current through the fluid, so that the electric current causes heating of the fluid by virtue of the fluids resistive properties, wherein the electric fluid heater defines a flow path from an inlet to an outlet and comprises at least first and second heating assemblies positioned in parallel along the flow path such that fluid passing along the flow path passes the first and second heating assemblies in parallel; and
a fluid receptacle within a heat exchanger for receiving heated fluid from the electric fluid heater and for transferring the heated fluid to a substance via the heat exchanger, wherein the substance to be heated is in proximity to the heat exchanger.

12. A heat generator according to claim 11, wherein the electric fluid heater comprises at least first, second and third parallel heating assemblies positioned along the flow path such that fluid passes through all three heating assemblies simultaneously.

13. A heat generator according to claim 12, wherein at least one of the heating assemblies of the electric fluid heater comprises at least one segmented electrode, the segmented electrode comprising a plurality of electrically separable elements allowing an effective active area of the segmented electrode to be controlled by selectively activating the elements such that upon application of a voltage to the segmented electrode current drawn will depend upon the effective active area.

14. A heat generator according to claim 12, wherein at least one of the heating assemblies of the electric fluid heater comprises at least one segmented electrode, and the heat generator further comprises control means operable to optimise the power applied to the heated fluid by selectively activating or deactivating elements of the one or more segmented electrodes.

15. A heat generator according to claim 14, where the control means is further operable to optimise the power applied to the heated fluid by repeatedly measuring the temperature outputs of each of the heating assemblies and comparing the measured temperature outputs with calculated output temperature values.
